(19) United States
(12) Patent Application Publication
(10) Pub. No.: US 2012/0017459 A1
(43) Pub. Date: Jan. 26, 2012

(54) HAND DRYER

(75) Inventors: Hitoshi Kikuchi, Tokyo (JP); Fumikazu Matsuura, Tokyo (JP); Keiji Kameishi, Tokyo (JP); Kenji Sawabe, Tokyo (JP); Yoshihiro Fukaya, Tokyo (JP)

(73) Assignee: Mitsubishi Electric Corporation, Chiyoda-ku, Tokyo (JP)

(21) Appl. No.: 13/143,455

(22) PCT Filed: Feb. 20, 2009
(86) PCT No.: PCT/JP2009/053082

§ 371 Date: Jul. 6, 2011

(51) Int. Cl. F26B 21/00

(52) U.S. Cl. 34/202

(57) ABSTRACT

A hand dryer includes a hand drying chamber that includes a hand insertion opening from which a hand is inserted, a first wall section that faces the hand inserted from the hand insertion, opening, a second wall section that faces the hand and the first wall section, and a plurality of air nozzle sections, which extends in a direction from the hand insertion opening to a far side and jets a high-speed air, on any one of the first wall section and the second wall section, wherein a distance between the first wall section or the second wall section that faces the air nozzle sections and the air nozzle sections is large in an upper portion and is small in a lower portion.

### TECHNICAL FIELD

The present invention relates to a hand dryer that hygienically performs a drying process by jetting a high-speed airflow onto wet hands after having been washed.

### BACKGROUND ART

Conventionally, a hand dryer has been developed that hygienically performs a hand drying process, in which wet hands after having been washed are dried by blowing water away by jetting high-speed airflow, rather than being wiped on a towel or a handkerchief. As such the hand dryer, a hand dryer is disclosed that is provided with two air nozzle sections that jet high-speed airflows (for example, see Patent Document 1). The two air nozzle sections are provided on a near side and a far side of an opening of a hand drying chamber to face each other. Wind is simultaneously applied to both a palm and a back of a hand, so that water is blown away from the hand, thereby drying the hand.

In addition, a hand dryer is disclosed that has a hand drying chamber including a hand insertion opening, a rear wall section, a front wall section, and a pair of air nozzles. A left hand and a right hand can be inserted in parallel into the hand insertion opening. The rear wall section faces backs of the left hand and the right hand that are inserted in parallel from the hand insertion opening. The front wall section faces palms of the left and the right hand, and the rear wall section. The pair of air nozzles is arranged in respective centers of the rear wall section and the front wall section to extend roughly along an overall length of the hands, almost in parallel with a direction of fingers on the left hand and the right hand inserted in parallel. The pair of air nozzles respectively jet high-speed airflows to the left and to the right to be almost parallel with the backs and the palms of the left hand and the right hand (for example, see Patent Document 2).

In addition, a hand dryer is disclosed that has a hand drying chamber (processing space) including a hand insertion opening (opening section) provided on an upper portion, a rear wall section (back surface), a front wall section opposing the rear wall section, and four jetting nozzles arranged to extend in a vertical direction on the front wall section (for example, see Patent Document 3). The four jetting nozzles jet high-speed airflows obliquely upward towards the rear wall section.

Patent Document 1: Japanese Patent Application Laid-open No. 2003-180554 (pp. 2 and 3, and FIGS. 1 and 9)

Patent Document 2: Japanese Patent Application Laid-open No. 2005-087283 (p. 6, and FIGS. 1 to 5)

Patent Document 3: Japanese Patent Application Laid-open No. 2006-187397 (pp. 6 and 7, and FIGS. 4 and 5)

### DISCLOSURE OF INVENTION

### Problem To Be Solved By The Invention

However, the hand dryer disclosed in Patent

Document 1 is problematic in that the high-speed airflows jetted from the two opposing air nozzle sections collide with each other. Therefore, a disruption occurs in the airflows, thereby causing noise.

The hand dryer disclosed in Patent Document 2 is problematic in that the pair of air nozzles respectively jet the high-speed airflows to the left and to the right to be roughly parallel with the palms and backs of the left hand and the right hand. Therefore, water on the hands is difficult to remove. In particular, the airflows do not pass between fingers. Therefore, water attached between the fingers is hardly removed.

The hand dryer disclosed in Patent Document 3 is problematic in that, because the high-speed airflows are jetted obliquely upward from the front wall section towards the rear wall section, the high-speed airflows come into contact with the hands from below. Therefore, the high-speed airflows blow towards a user from the opening section above with water droplets that are removed from the hands.

The present invention has been achieved in light of the above-described problems. An object of the present invention is to provide a hand dryer that makes little noise, can remove even water attached between fingers, and causes minimal splashing of water droplets onto a user.

### MEANS FOR SOLVING PROBLEM

To solve the above problems and to achieve the above objects, a hand dryer according to the present invention includes a hand drying chamber that includes a hand insertion opening that is provided in an upper portion and from which a left hand and a right hand can be inserted in parallel; a rear wall section that faces the hands inserted from the hand insertion section; a front wall section that faces the hands and the rear wall section; a pair of air nozzle sections that is set on a side of the rear wall section to extend in a vertical direction roughly along an overall length of the inserted hands, and that jets a high-speed airflow obliquely downward toward the hands; and a lateral opening section that allows the airflow jetted from the air nozzle sections to flow out after a hand drying process.

### EFFECT OF THE INVENTION

According to the present invention, a hand dryer achieves advantageous effects in that the hand dryer makes little noise, removes even water attached between fingers, and causes minimal splashing of water droplets onto a user.

### BRIEF DESCRIPTION OF DRAWINGS

FIG. 1 is a side view of a hand dryer according to a first embodiment of the present invention.

FIG. 2 is a front view of the hand dryer according to the first embodiment.

FIG. 3 is a side view of when hands are inserted into the hand dryer according to the first embodiment and twisted.

FIG. 4 is a longitudinal cross-sectional view of relative positions of air nozzle sections of the hand dryer according to the first embodiment and inserted hands.

FIG. 5 is a transverse cross-sectional view taken along line A-A in FIG. 1.

FIG. 6 is a diagram of an air jet opening of the hand dryer according to the first embodiment.

FIG. 7 is a diagram of a modified example of the air jet opening of the hand dryer according to the first embodiment.

FIG. 8 is a Diagram of another modified example of the air jet opening of the hand dryer according to the first embodiment.

FIG. 9 is a diagram of still another modified example of the air jet opening of the hand dryer according to the first embodiment.

FIG. 10 is a side view of a modified example of the air nozzle sections of the hand dryer according to the first embodiment.

FIG. 11 is a transverse side view of a hand dryer according to a second embodiment.

FIG. 12 is a transverse side view of a hand dryer according to a third embodiment.

FIG. 13 is a transverse side view of a hand dryer according to a fourth embodiment.

FIG. 14 is a side view of a hand dryer according to a fifth embodiment.

FIG. 15 is a side view of a hand dryer according to a sixth embodiment.

FIG. 16 is a side view of a hand dryer according to a seventh embodiment.

FIG. 17 is a side view of a hand dryer according to an eighth embodiment.

FIG. 18 is a transverse cross-sectional view of a modified example of the hand dryer according to the third embodiment.

### EXPLANATIONS OF LETTERS OR NUMERALS

1 main body casing

2 hand drying chamber

3, 3a, 3b, 3c, 3d, 3f, 3g front wall section

4 rear wall section

5, 5a, 5b, 5c, 5d, 5f, 5g inner surface of front wall section

6 inner surface of rear wall section

8 bottom surface

9 hand insertion opening

10 lateral opening section

11 high-pressure airflow generating unit

12 airflow path

13, 13a air nozzle section

14 high-speed airflow

15 drain

16 drain pipe

17 drain tank

18 control circuit

19 air inlet

20 inlet passage

21 suction opening

22 hand detecting sensor

24, 24a, 24b air jet opening

25 filter

81, 82, 83, 84, 85, 86, 87, 88 hand dryer

### BEST MODE(S) FOR CARRYING OUT THE INVENTION

Exemplary embodiments of a hand dryer according to the present invention will be explained in detail below with reference to the accompanying drawings. The present invention is not limited to the embodiments.

First Embodiment.

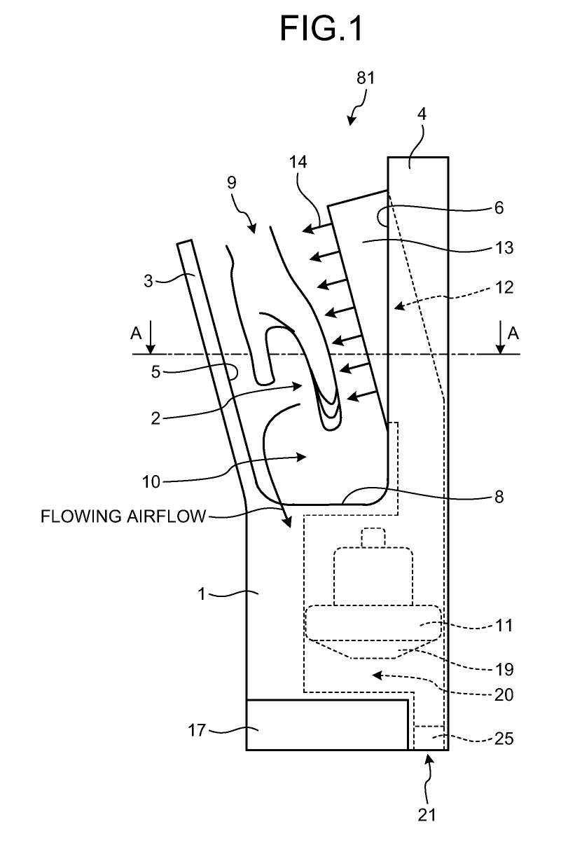

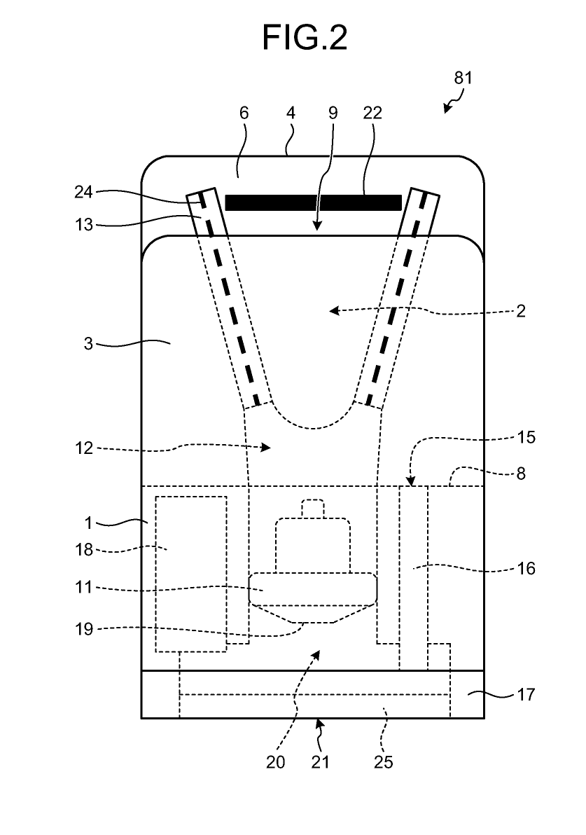

FIG. 1 is a side view of a hand dryer according to a first embodiment of the present invention. FIG. 2 is a front view of the hand dryer according to the first embodiment. As shown in FIG. 1 and FIG. 2, in a hand dryer 81 according to the first embodiment, a hand drying chamber 2 is formed in an upper portion of a main body casing 1. The hand dryer 81 is used by fixing the main body casing 1 onto a wall surface, such as that of a rest room, through use of a screw and the like.

A front wall section 3 is formed on an upper front side (user side) of the main body casing 1. A rear wall section 4 is formed on an upper back side. The hand drying chamber 2 is surrounded by an inner surface 5 of the front wall section 3, an inner surface 6 of the rear wall section 4, and a bottom surface 8. The bottom surface 8 receives water droplets blown from hands. A hand insertion opening 9 is formed in an upper portion of the hand drying chamber 2. Hands are inserted into and removed from the hand insertion opening 9. Lateral opening sections 10 are formed in both lateral directions. The lateral opening sections 10 allow air to flow out after a hand drying process.

A high-pressure airflow generating unit 11 is arranged in a lower portion of the main body casing 1. High-pressure airflows generated by the high-pressure airflow generating unit 11 are led to air nozzle sections 13 provided on the rear wall section 4, by way of an airflow path 12 formed in the rear wall section 4.

The hands of a user are inserted into the hand drying chamber 2 at an angle, such that wrists are on a near side and fingertips are on a far side (rear side), in a state in which a left hand and a right hand of the user standing in front of the main body casing 1 are naturally aligned in parallel in a lateral direction.

The air nozzle sections 13 are formed (set) projecting from the inner surface 6 of the rear wall section 4, in positions respectively facing the left hand and the right hand that are inserted into the hand drying chamber 2. Longitudinal directions of the air nozzle sections 13 extend to be almost parallel with directions of respective fingers of the hands inserted in the vertical direction. The air nozzle sections 13 are formed at a forward-tilt angle of 5 degrees to 45 degrees, such that upper portions are on the near side and lower portions are on the far side (rear side). The direction of a finger is approximately a direction of a middle finger when the hand is naturally spread. The inner surface 5 of a second wall section 3 is formed at a forward-tilt angle, such that the hands can be easily inserted into the hand drying chamber 2 and a distance between the hands and the air nozzle sections 13 is almost constant.

The hand dryer 81 is configured such that high-speed airflows 14 (wind speed: 50 m/s to 250 m/s) are jetted into the hand drying chamber 2 from the air nozzle sections 13. Water on the left hand and the right hand, inserted into the hand drying chamber 2, is blown towards the inner surface 5 of the front wall section 3. The water droplets that have been blown are collected on the inner surface 5 of the front wall section 3 and the bottom surface 8. The collected water droplets then pass through a drain 15 and a drain pipe 16, and are collected in a drain tank 17. The drain tank 17 can be attached and removed freely from the main body casing 1 by being slid forward and backward. A removal lid covers the drain tank 17.

The high-pressure airflow generating unit 11 includes a DC brushless motor (alternatively, an ordinary commutator motor or induction motor can also be used), a motor driving circuit, and a turbo-fan driven by the DC brushless motor. The high-pressure airflow generating unit 11 is automatically operated by a control circuit 18. An air inlet 19 of the high-pressure airflow generating unit 11 opposes an inlet passage 20 provided within the main body casing 1. The air inlet 19 suctions external air from a suction opening 21 on a lower end of the inlet passage 20. A filter 25 removes dust and moisture from the air suctioned from the suction opening 21. The air is then supplied to the high-pressure airflow generating unit 11.

A hand detecting sensor 22 is provided on the inner surface 6 of the rear wall section 4. Whether the hands are inserted into the hand drying chamber 2 from the hand insertion opening 9 is detected by a detection signal from the hand detecting sensor 22. The detection signal from the hand detecting sensor 22 is input into the control circuit 18 that includes a microcomputer. When the control circuit 18 judges that the hands are inserted, the control circuit 18 electrifies the high-pressure airflow generating unit 11 to jet the high-speed airflows from the air nozzle sections 13.

When the left hand and right hand are inserted into the hand drying chamber 2 from the hand insertion opening 9 of the hand dryer 81 in parallel up to the vicinity of the wrists in a natural state, the hand detecting sensor 22 detects insertion of the hands. The high-pressure airflow generating unit 11 operates under the control of the control circuit 18. The high-speed airflow 14 is jetted from the air nozzle section 13 obliquely downward, towards a front side of the hand drying chamber 2.

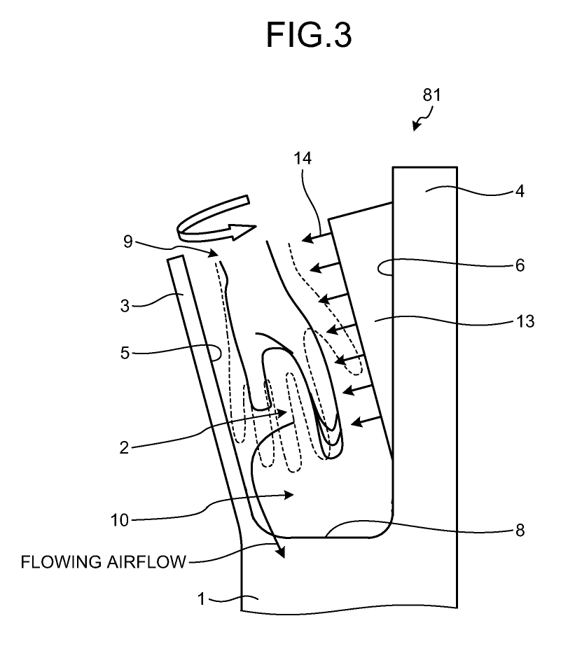

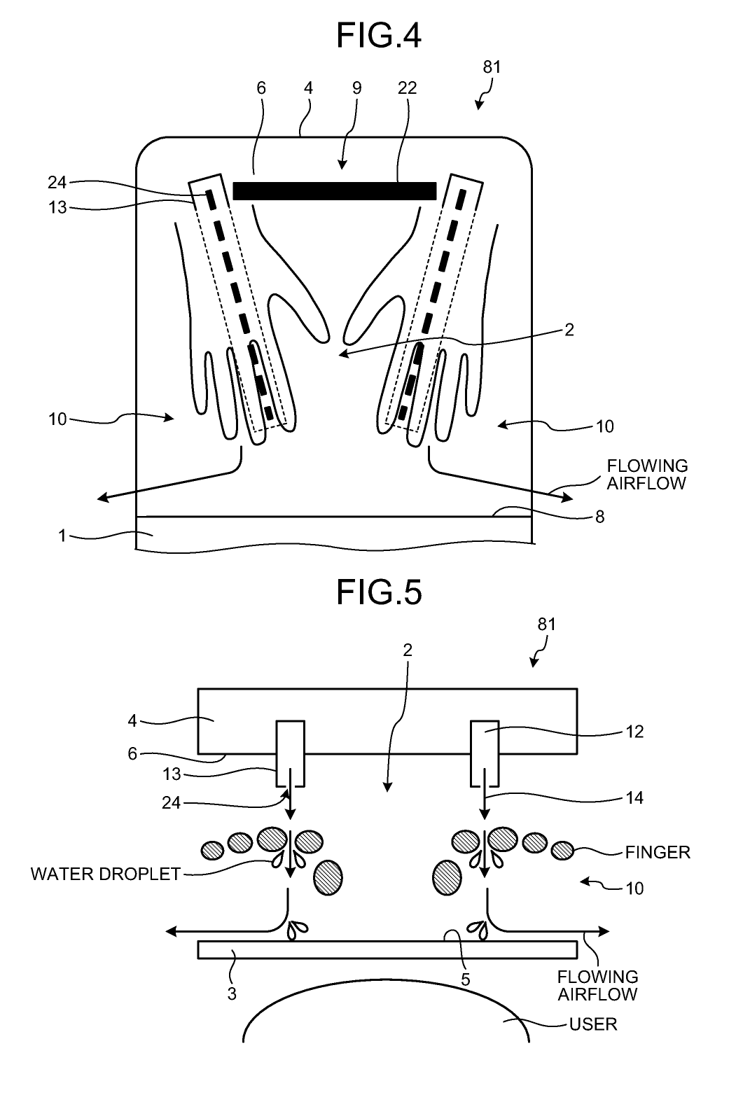

FIG. 3 is a side view of when the hands are inserted into the hand dryer according to the first embodiment and twisted. FIG. 4 is a longitudinal cross-sectional view of relative positions of the air nozzle sections of the hand dryer according to the first embodiment and the inserted hands. As shown in FIG. 3 and FIG. 4, when the hands are twisted front and back, such that the palms are turned by flipping the wrists, the high-speed airflows 14 jetted from the air nozzle sections 13 come into contact with the entire hands and pass between the fingers, blowing water from the hands.

FIG. 5 is a transverse cross-sectional view taken along line A-A in FIG. 1. As shown in FIG. 5, the high-speed airflows 14 that have come into contact with the hands, passed between the fingers, and blown the water droplets change directions of flow after coming into contact with the inner surface 5 of the front wall section 3. The high-speed airflows 14 then flow outside from the lateral opening sections 10. At this time, the blown water droplets are separated from the airflow by inertia force, because of the change in the direction of flow of the high-speed airflows 14. The water droplets run down the inner surface 5 of the front wall section 3 and the bottom surface 8, and are collected by the drain 15 (see FIG. 2). The water droplets then pass through the drain pipe 16 and are collected in the drain tank 17.

The front wall section 3 blocks the high-speed airflows 14 in front of the user. Therefore, the user is not exposed to the high-speed airflows 14 and the water droplets. After a hand drying process is completed and the hands are removed from the hand drying chamber 2, the hand detecting sensor 22 detects that the hands have been removed and stops the high-pressure airflow generating unit 11.

Next, the air nozzle sections 13 will be explained in detail. When the hand dryer 81 is used, the hands of the user are inserted into the hand drying chamber 2 at an angle, such that the wrists are on the near side and the fingertips are on the far side (rear side), in a state in which the left hand and the right hand of the user standing in front of the main body casing 1 are naturally aligned in parallel in the lateral direction.

The air nozzle sections 13 extend in a vertical direction on the rear wall section 4 that face each hand inserted into the hand drying chamber 2. The air nozzle section 13 is arranged at a frontward tilt such that the upper portion is positioned towards the front side and the lower portion is positioned towards the far side (rear side). As a result of the positioning of the air nozzle sections 13, the high-speed airflows 14 jetted from the air nozzle sections 13 flow from the far side of the hand drying chamber 2 towards the near side, advancing obliquely downward, in a shape of an air curtain extending in the vertical direction.

The high-speed airflows 14 come into contact with the entire hands at the same time, from the wrist to the fingertips of each hand. The high-speed airflows 14 also pass between the fingers. Therefore, when the front and the back of the hands are placed in contact with the high-speed airflows 14 by twisting the hands at the wrist, water on the front and the back of the hands and between the fingers are blown. Therefore, the entire hands can be dried without moving the hands in the vertical direction.

As shown in FIG. 3, the air nozzle sections 13 are respectively arranged in positions opposing the left hand and the right hand inserted into the hand drying chamber 2. Therefore, the distance between the hand and the air nozzle section 13 can be shortened. The air nozzle section 13 extends in the vertical direction on the rear wall section 4 and is arranged at a forward-tilt angle such that the upper portion is positioned towards the near side and the lower portion is positioned towards the far side. Therefore, the distance between the hand and the air nozzle section 13 is almost constant from the wrist to the fingertips. As a result, the high-speed airflow 14 comes into contact with the entire hand at a constant speed, without reduction in flow rate and while maintaining high kinetic energy. Thus, water is efficiently and evenly removed from the hands.

In a conventional hand dryer in which a high-speed airflow is jetted obliquely upward into a drying space from a front wall section towards a rear wall section, an air jet opening is open in an upward direction in relation to the drying space. Therefore, a problem occurs in that water droplets within the drying space enter a main body. In the hand dryer 81 according to the first embodiment, air jet openings 24 of the air nozzle sections 13 face downward. Therefore, the water droplets within the hand drying chamber 2 are prevented from entering the main body casing 1 from the air jet openings 24. The air nozzle sections 13 are provided only on the rear wall section 4 side. No air nozzles are arranged on the front wall section side 3. Therefore, collision between the jetted high-speed airflows 14 does not occur, so that noise caused by collision between high-speed airflows does not occur. Thus, the hand dryer 81 makes less noise.

The high-speed airflow 14 is jetted obliquely downward and blows the water droplets in a direction along gravitational force. Therefore, water on the hands can be efficiently removed. Moreover, airflow after the hands are dried is also obliquely downward. As shown in FIG. 3, the air flows from the hand drying chamber 2 downwards to the lateral opening sections 10, and does not flow out of the hand insertion opening 9. Therefore, the user is minimally exposed to wind and water droplets.

When the user standing in front of the main body casing 1 naturally inserts both hands into the hand drying chamber 2 to be aligned in parallel in the lateral direction, the left hand and the right hand is roughly parallel or, as shown in FIG. 4, the space between the left hand and the right hand is large on the wrist side and small on the fingertip side. Therefore, an angle formed by a pair of the air nozzle sections 13 is set to 0 degrees to 60 degrees (a V-shape of about 20 degrees for an ordinary adult person) so that space between a pair of the air nozzle sections 13 in the lateral direction is formed to be large on a hand insertion side and small on the far side. As a result, the angle formed by the left hand and the right hand, and the angle formed by a pair of the air nozzle sections 13 match. Thus, the high-speed airflows 14 come into contact with the entire hands and between the fingers, resulting in high water-removal performance.

In a conventional hand dryer in which high-speed airflows are jetted from a pair of air nozzles arranged facing each other, the high-speed airflows come into simultaneous contact with the palm side and the back side of the hands. Therefore, in spaces between the fingers that are not blocked by the hands, each airflow collides with the opposing airflow. Thus, wind speed drops, causing a problem in that water on side surfaces of the fingers cannot be sufficiently removed.

In the hand dryer 81 according to the first embodiment, because a pair of the air nozzle sections 13 does not oppose each other, the high-speed airflows come into contact with every part of the hands while maintaining wind speed. Because the air nozzle sections 13 extend in the vertical direction, as shown in FIG. 5, the jetted high-speed airflows 14 enter gaps between the fingers. Thus, water on the side surfaces of the fingers can be efficiently removed.

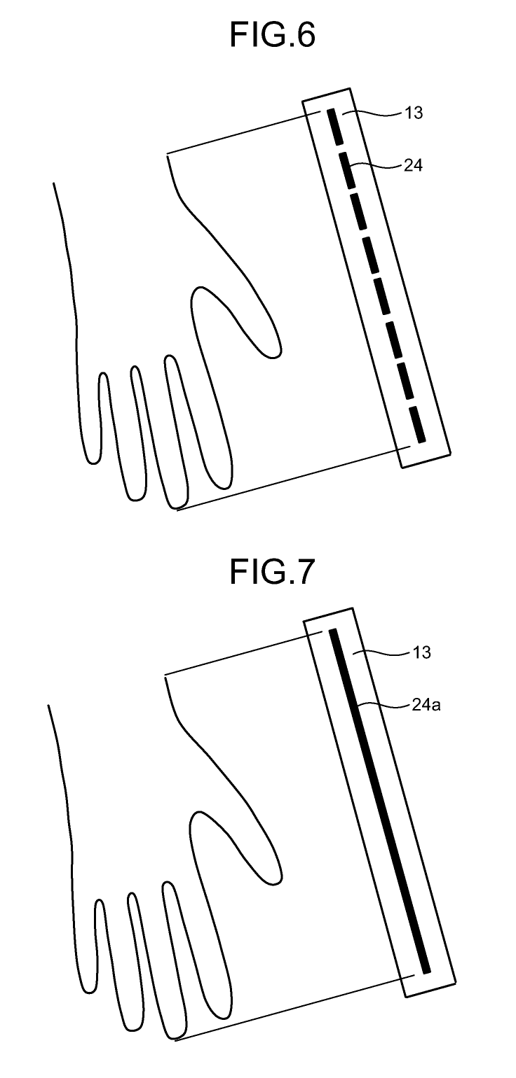

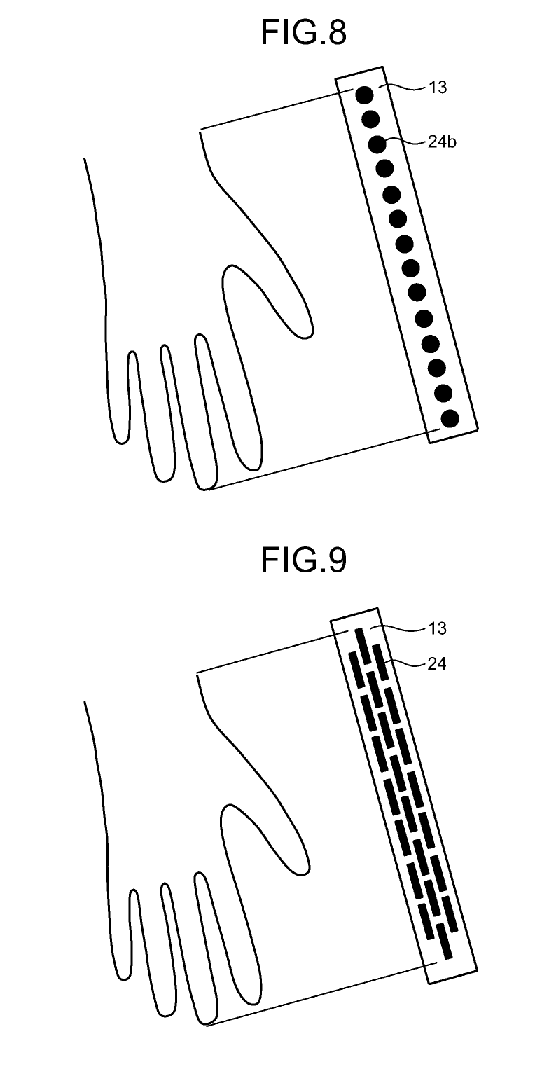

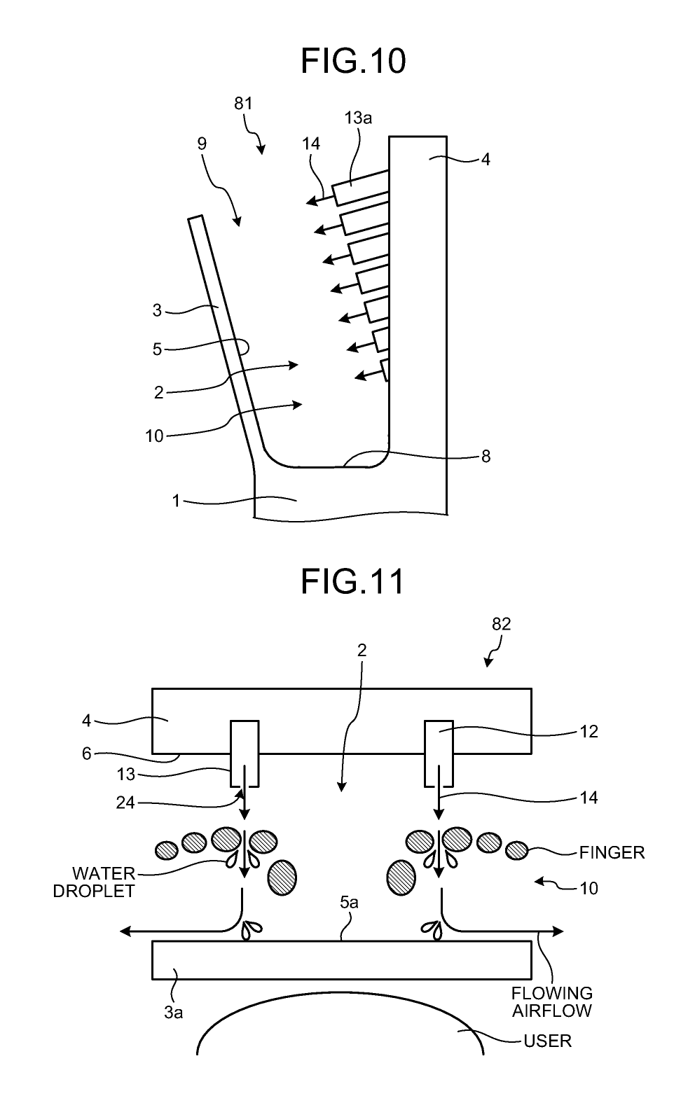

Next, an air jet opening of the air nozzle section 13 will be explained in detail. FIG. 6 is a diagram of the air jet opening of the hand dryer according to the first embodiment. FIG. 7 is a diagram of a modified example of the air jet opening. FIG. 8 is a diagram of another modified example of the air jet opening. FIG. 9 is a diagram of still another modified example of the air jet opening. FIG. 10 is a side view of a modified example of the air nozzle section.

As shown in FIG. 6, in the air nozzle section 13 of the hand dryer according to the first embodiment, long hole-shaped air jet openings 24 are successively arranged in a row forming a broken line. The air nozzle section 13 achieves excellent drying performance and noise performance. As shown in FIG. 7, the air jet opening can be a slit-shaped air jet opening 24a. As shown in FIG. 8, round hole-shaped air jet openings 24b can be successively provided in a row forming a broken line. As shown in FIG. 9, the long hole-shaped air jet openings 24 can be successively arranged in a plurality of rows forming broken lines. The air nozzle section 13 is not necessarily required to be integrally formed. As shown in FIG. 10, a plurality of air nozzle sections 13a can be successively arranged in a row forming a broken line.

A length of the row of air jet openings 24, 24a, and 24b is a length from the wrist of the hand to the tip of the middle finger or longer (150 mm or more according to the first embodiment), such that the high-speed airflow come into simultaneous contact with the entire hand. Thus, water can be efficiently removed.

As shown in FIG. 5, the air nozzle section 13 is formed to project from the inner surface 6 of the rear wall section 4 of the hand drying chamber 2 so that the distance between the hand and the air nozzle section 13 is made small. Moreover, areas of the hand insertion opening 9 and the lateral opening sections 10 are made large. As a result, the wind speed of the air flow including the water droplets flowing from the hand drying chamber 2 decreases. Thus, an amount of water droplets flowing out of the hand drying chamber 2 can be reduced.

The air nozzle section 13 is formed to project from the inner surface 6 of the rear wall section 4. Therefore, the rear wall section 4 does not block view, so that an interior of the hand drying chamber 2 can be viewed from above the hand drying chamber 2. Thus, a degree to which the hands are dried is easily visible.

Second Embodiment.

FIG. 11 is a transverse cross-sectional view of a hand dryer according to a second embodiment. As shown in FIG. 5, the front wall section 3 of the hand dryer 81 according to the first embodiment is plate-shaped. However, as shown in FIG. 11, a front wall section 3a of a hand dryer 82 according to the second embodiment has a hollow box-shaped structure including an inner surface 5a to increase strength.

Third Embodiment.

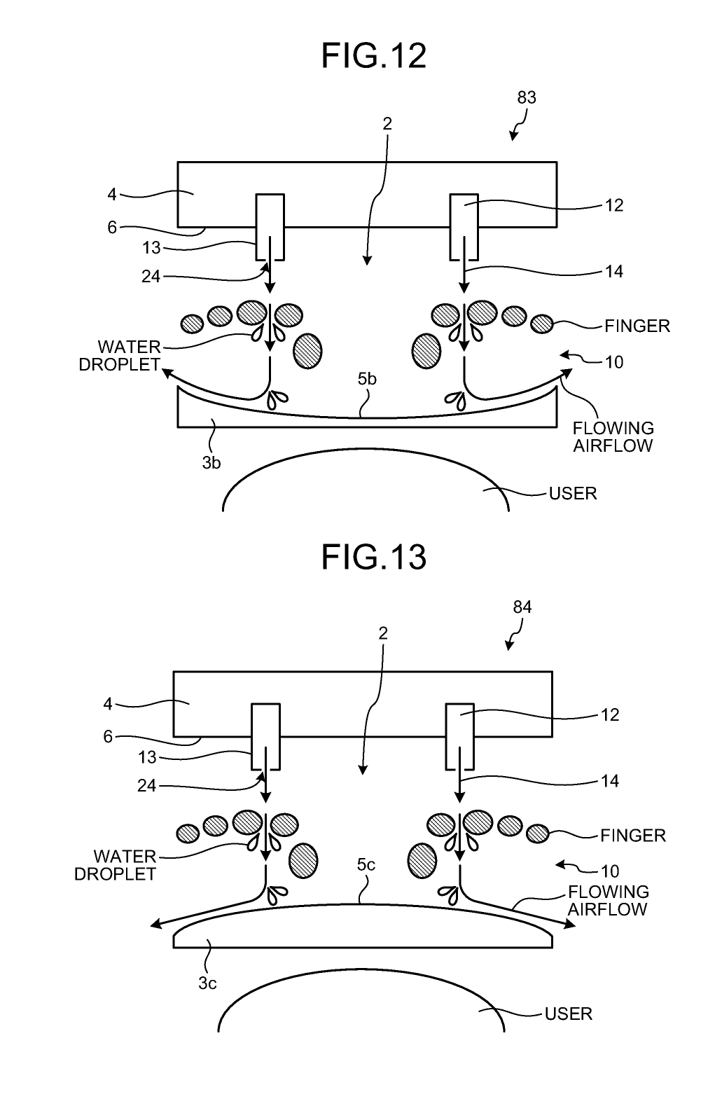

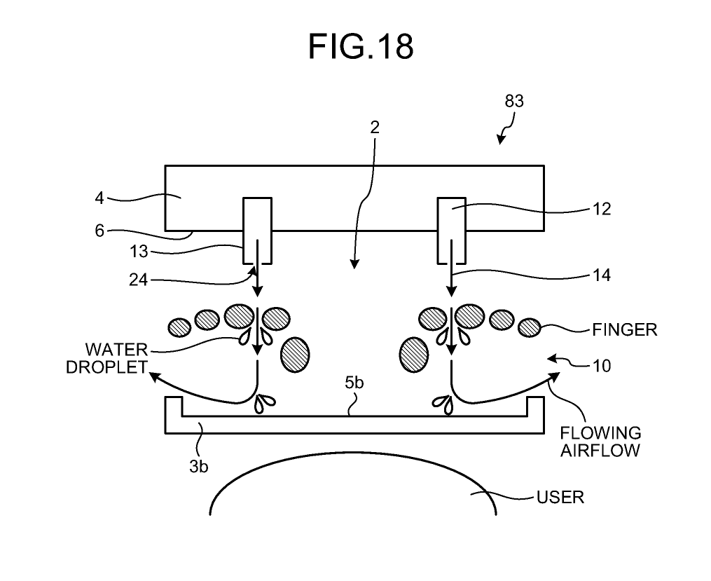

FIG. 12 is a transverse cross-sectional view of a hand dryer according to a third embodiment. The inner surface 5 of the front wall section 3 according to the first embodiment and the inner surface 5a of the front wall section 3a according to the second embodiment are planar. However, as shown in FIG. 12, an inner surface 5b of a front wall section 3b of a hand dryer 83 according to the third embodiment has a concave horizontal cross-section. The concave inner surface 5b according to the third embodiment allows airflows that have come into contact with the hands and include water droplets to flow from the lateral opening sections 10 toward the rear wall section 4 side. Therefore, exposure of the user to the airflows and the water droplets can be further reduced. FIG. 18 is a transverse cross-sectional view of a modified example of the hand dryer according to the third embodiment. The inner surface 5b of the front wall section 3b of the hand dryer 83 according to the third embodiment has a concave horizontal cross-section. However, as shown in FIG. 18, both side portions of the front wall section 3b are bent roughly at a right angle towards the rear wall section 4 side. Even with this structure, a similar effect as that achieved by the above concave surface can be achieved. Moreover, as a result of the bent portions, water droplets attached to the inner surface 5b can be prevented from splashing outside from the lateral opening sections 10.

Fourth Embodiment.

FIG. 13 is a transverse cross-sectional view of a hand dryer according to a fourth embodiment. As shown in FIG. 13, an inner surface 5c of a front wall section 3c of a hand dryer 84 according to the fourth embodiment is a convex surface. The convex inner surface 5c according to the fourth embodiment allows airflows that have come into contact with the hands and include water droplets to flow from the lateral opening sections 10 towards the front side. Therefore, a wall surface on which the hand dryer 84 is set can be prevented from becoming soiled by the water droplets splashing onto the wall surface.

Fifth Embodiment.

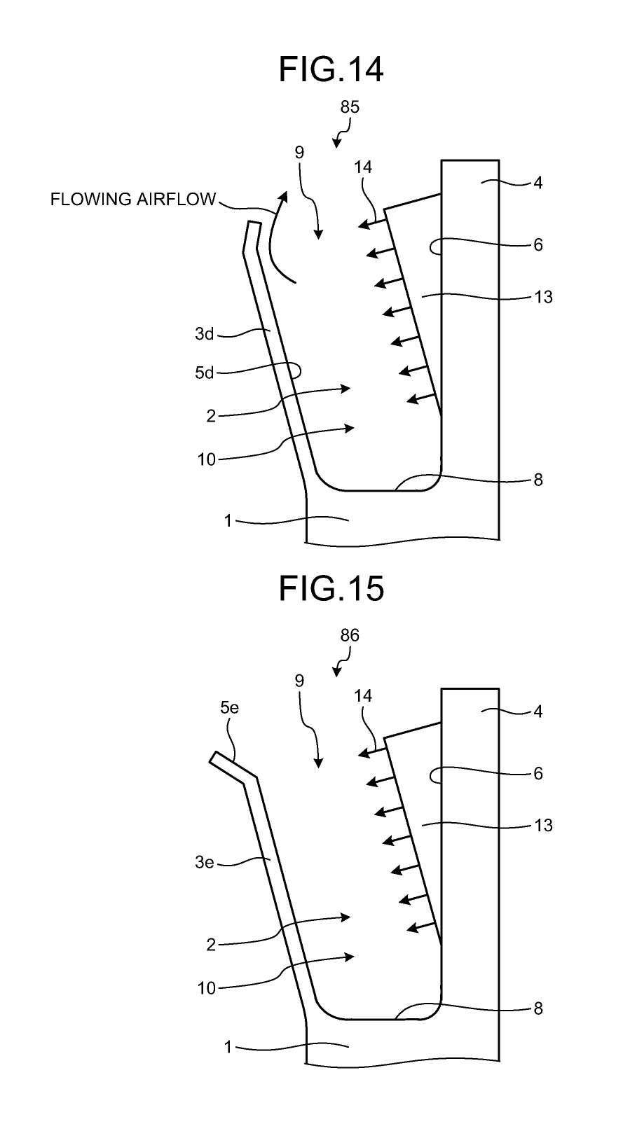

FIG. 14 is a side view of a hand dryer according to a fifth embodiment. As shown in FIG. 14, an inner surface 5d of a front wall section 3d of a hand dryer 85 according to the fifth embodiment is formed such that an upper portion is curved to the rear side (to the rear wall section 4 side). The inner surface 5d according to the fifth embodiment of which the upper portion is curved towards the rear side directs a flow of air flowing upwards from the hand insertion opening 9 of the hand drying chamber 2 in a direction away from the user, preventing the user from being exposed to the flowing air and water droplets.

Sixth Embodiment.

FIG. 15 is a side view of a hand dryer according to a sixth embodiment. As shown in FIG. 15, an inner surface 5e of a front wall section 3e of a hand dryer 86 according to the sixth embodiment is formed such that an upper portion is curved towards the front side (user side). The inner surface 5e according to the sixth embodiment of which the upper portion is curved towards the front side widens the hand insertion opening 9 of the hand drying chamber 2, allowing the user to more easily insert the hands into the hand drying chamber 2, whereby usability is enhanced.

Seventh Embodiment.

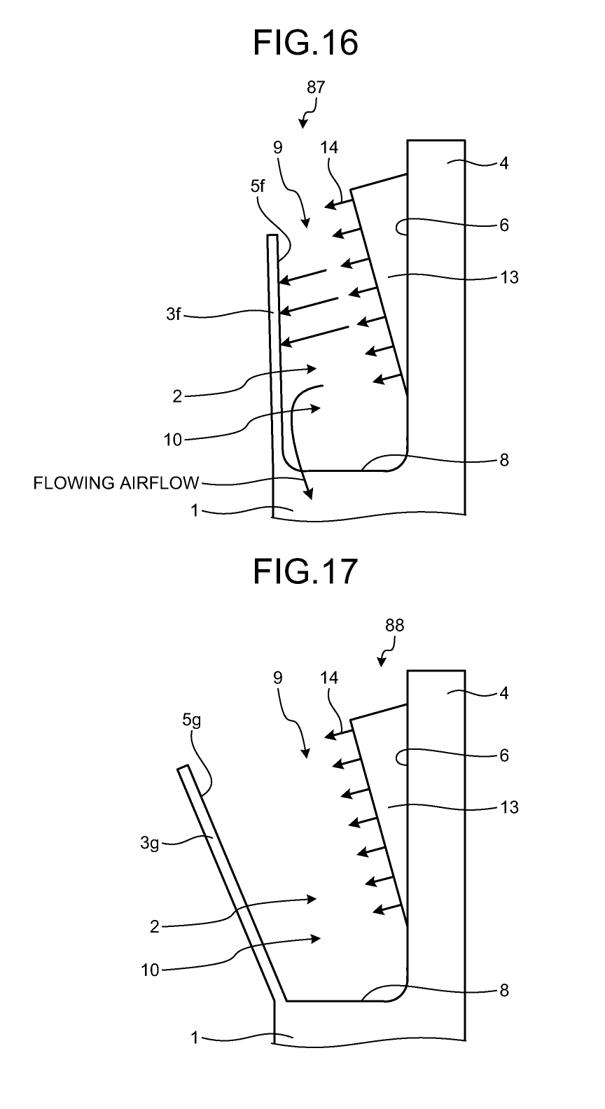

FIG. 16 is a side view of a hand dryer according to a seventh embodiment. In the hand dryers according to the first embodiment to the sixth embodiment, the inner surface of the front wall section is tilted forwards to be roughly parallel with the air nozzle sections 13 to facilitate insertion of the hands and prevent water droplets from splashing onto the user. As shown in FIG. 16, in a hand dryer 87 according to the seventh embodiment, a forward-tilt angle of an inner surface 5f of a front wall section 3f is made smaller than a forward-tilt angle of the air nozzle section 13, and a distance between the inner surface 5f of the front wall section 3f and the air nozzle sections 13 is short at an upper portion and wide at a lower portion. Therefore, airflows that have come into contact with the hands and include water droplets come into contact with the inner surface 5f of the front wall section 3f according to the seventh embodiment obliquely downward. Thus, airflows flowing from the hand insertion opening 9 can be suppressed. Accordingly, the user can be prevented from being exposed to flowing air and water droplets.

Eighth Embodiment.

FIG. 17 is a side view of a hand dryer according to an eight embodiment. As shown in FIG. 17, in a hand dryer 88 according to the eighth embodiment, a forward-tilt angle of an inner surface 5g of a front wall section 3g is greater than a forward-tilt angle of the air nozzle section 13, and a distance between the inner surface 5g of the front wall section 3g and the air nozzle sections 13 is wide at an upper portion and short at a lower portion. In the hand dryer 88 according to the eighth embodiment, the width of the hand insertion opening 9 of the hand drying chamber 2 is widened, allowing the user to more easily insert his hands into the hand drying chamber 2, whereby usability is enhanced.

### INDUSTRIAL APPLICABILITY

As described above, the hand dryer according to the present invention can be advantageously used as a hand dryer that hygienically performs a drying process by jetting a high-speed airflow onto wet hands after being washed.

1-16. (canceled)

17. A hand dryer comprising a hand drying chamber that includes
a hand insertion opening from which a hand is inserted,
a first wall section that faces the hand inserted from the hand insertion opening,
a second wall section that faces the hand and the first wall section, and
a plurality of air nozzle sections, which extends in a direction from the hand insertion opening to a far side and jets a high-speed air, on any one of the first wall section and the second wall section, wherein
a distance between the first wall section or the second wall section that faces the air nozzle sections and the air nozzle sections is large in an upper portion and is small in a lower portion.

18. The hand dryer according to claim 17, wherein the air nozzle sections are configured such that a plurality of air jet openings is arranged in a direction from the hand insertion opening to the far side.

19. The hand dryer according to claim 17, wherein
the hand insertion opening is provided in an upper portion of the hand drying chamber,
the first wall section is provided at a rear portion of the hand drying chamber,
the second wall section is provided at a front portion of the hand drying chamber, and
the air nozzle sections are provided on the first wall section.

20. The hand dryer according to claim 19, wherein an inner surface of the second wall section is formed to tilt forward so that an upper portion is positioned on a front side and a lower portion is positioned on a rear side.

21. The hand dryer according to claim 19, wherein an upper portion of an inner surface of the second wall section is bent toward a rear side.

22. The hand dryer according to claim 19, wherein an upper portion of an inner surface of the second wall section is bent toward a front side.

23. The hand dryer according to claim 17, wherein the air nozzle sections are arranged to tilt forward so that an upper portion is positioned on a front side and a lower portion is positioned on a rear side.

24. A hand dryer comprising a hand drying chamber that includes
a hand insertion opening from which a hand is inserted,
a first wall section that faces the hand inserted from the hand insertion opening,
a second wall section that faces the hand and the first wall section, and
a plurality of air nozzle sections, which extends in a direction from the hand insertion opening to a far side and jets a high-speed air, on any one of the first wall section and the second wall section, wherein
a distance between the first wall section or the second wall section that faces the air nozzle sections and the air nozzle sections is small in an upper portion and is large in a lower portion.

25. The hand dryer according to claim 24, wherein the air nozzle sections are configured such that a plurality of air jet openings is arranged in a direction from the hand insertion opening to the far side.

26. The hand dryer according to claim 24, wherein
the hand insertion opening is provided in an upper portion of the hand drying chamber,
the first wall section is provided at a rear portion of the hand drying chamber,
the second wall section is provided at a front portion of the hand drying chamber, and
the air nozzle sections are provided on the first wall section.

27. The hand dryer according to claim 26, wherein an inner surface of the second wall section is formed to tilt forward so that an upper portion is positioned on a front side and a lower portion is positioned on a rear side.

28. The hand dryer according to claim 26, wherein an upper portion of an inner surface of the second wall section is bent toward a rear side.

29. The hand dryer according to claim 26, wherein an upper portion of an inner surface of the second wall section is bent toward a front side.

30. The hand dryer according to claim 24, wherein the air nozzle sections are arranged to tilt forward so that an upper portion is positioned on a front side and a lower portion is positioned on a rear side.
